(19) United States
(12) Patent Application Publication
(10) Pub. No.: US 2018/0001118 A1
(43) Pub. Date: Jan. 4, 2018

(54) HORIZONTAL BLADE TRUNK OPENING TOOL

(71) Applicant: New Mexico Tech Research Foundation, Socorro, NM (US)

(72) Inventors: Robert Abernathy, Socorro, NM (US); Paul Giannuzzi, Socorro, NM (US)

(21) Appl. No.: 15/631,775

(22) Filed: Jun. 23, 2017

Related U.S. Application Data
(60) Provisional application No. 62/356,824, filed on Jun. 30, 2016.

(51) Int. Cl. A62B 3/00

(52) U.S. Cl. CPC A62B 3/005

(57) ABSTRACT

Remotely opening a trunk of an automobile or other enclosure comprises an assembly configured to use an explosive force to explosively driven upward into the trunk of a vehicle forcing the trunk open. The opening is achieved without disturbing the contents of the trunk or creating excessive collateral damage. The assembly includes a steel flier plate positioned on a support structure that is propelled into an automobile trunk lid to cause the trunk to open. The steel flier plate is a flat, metal bar that has detonating cord affixed thereon. The steel flier plate is held by a support structure that is sufficient to position the blade in an appropriate location proximate to the trunk to be open. The support structure further includes a non-fragmenting backing board to tamp the explosive charge in the opposite direction of the horizontal blade.

### RELATED APPLICATION

This application claims priority to U.S. Provisional Patent Application No. 62/356,824, filed Jun. 30, 2016 and entitled “Horizontal Blade Trunk Opening Tool.” The complete disclosure of the above-identified priority application is hereby fully incorporated herein by reference.

### TECHNICAL FIELD

The present disclosure relates to providing a method of remotely opening a trunk of an automobile or other enclosure without disturbing the contents of the trunk or creating excessive collateral damage.

### BACKGROUND

When attempting to force open an automobile trunk or other enclosure, operators often would like to perform the task remotely. This desire may be due to concerns for the safety of the operator when the contents of the trunk are unknown. However, conventional devices that remotely open a trunk typically damage any items or material inside the trunk. That is, if explosives or other blunt force devices are used to open the trunk, the rear of the vehicle may crumple to an extent that the contents of the trunk are damaged, or the opening device itself may enter the trunk and cause damage. This is especially dangerous in situations in which the contents of the vehicle trunk are hazardous. Additionally, when these devices are used, shrapnel and other materials create additional hazards to the surrounding area.

### SUMMARY

Techniques herein provide a vehicle trunk opening assembly to remotely open a trunk of an automobile or other enclosure without disturbing the contents of the trunk or creating excessive collateral damage. The opening assembly includes a steel flier plate, the steel flier plate being a flat metal plate to be propelled by a controlled explosion into a lid of a vehicle trunk. The opening assembly includes a backing board assembly positioned behind the explosive charge to damp an explosive force in a direction opposite the direction in which the steel flier plate is propelled. The opening assembly employs an explosive device affixed to the steel flier plate that is sized to propel the steel flier plate in a direction and with sufficient velocity to force open the lid without causing damage to one or more products inside the vehicle trunk. The opening assembly is affixed to a support structure that positions the assembly in place adjacent to the vehicle trunk to be opened.

In certain other example aspects described herein, methods to assemble and operate the opening assembly are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is an illustration depicting a perspective view of an opening assembly adjacent to a vehicle trunk, in accordance with certain examples.

FIG. 2 is an illustration depicting a side view of an opening assembly adjacent to a vehicle trunk, in accordance with certain examples.

FIG. 3 is an illustration depicting a front view of a backing board assembly, in accordance with certain examples.

FIG. 4 is an illustration depicting a front view of a steel flier plate with an explosive device affixed, in accordance with certain examples.

FIG. 5A is an illustration depicting a front view of an opening assembly, in accordance with certain examples.

FIG. 5B is an illustration depicting a side view of an opening assembly, in accordance with certain examples.

FIG. 6 is an illustration depicting a front view of an opening assembly positioned on a support structure, in accordance with certain examples.

FIG. 7 is an illustration depicting a side view of an opening assembly positioned on a support structure, in accordance with certain examples.

FIG. 8 is a block flow diagram depicting a method for an opening assembly to be assembled and operated, in accordance with certain examples.

### DETAILED DESCRIPTION OF EXAMPLE EMBODIMENTS

### Overview

The example embodiments described herein provide a steel flier plate positioned on a support structure that is propelled into an automobile trunk lid to cause the trunk to open. In an example embodiment, the steel flier plate is a flat, metal bar that has detonating cord affixed thereon. The steel flier plate is positioned on a support structure that is sufficient to position the blade in an appropriate location proximate to the trunk to be opened. The support structure further includes a non-fragmenting backing board to support the horizontal blade. The tool was designed to open the trunk regardless of the position of the lock, such as on a vehicle with the lock offset from the latch.

In an example, an operator may desire to remotely open a trunk of a vehicle or other enclosure without disturbing the contents of the trunk or creating excessive collateral damage. For example, the vehicle may be suspected of containing illegal or dangerous items. The operator may be affiliated with a law enforcement organization, the military, or any other suitable group. The operator may be charged with opening the trunk for inspection. If the items in the vehicle are potentially dangerous, the operator may desire to open the trunk remotely and without disturbing the contents of the trunk.

The steel flier plate of the invention is a flat section of metal that is propelled into the trunk lid. In the example, the steel flier plate is a section of steel strap that is approximately 3 feet long, 2 inches wide, and ¼ inches thick. The steel flier plate may be constructed of any suitable metal, such as iron, carbon steel or stainless steel. Other sizes of steel flier plate may be suitable for different vehicle sizes or applications.

An explosive device is affixed to the steel flier plate to propel the steel flier plate into the trunk. In an example, the explosive device is comprised of 2-3 strips of 50 grain detonating cord. Any other explosive device or material may be utilized if it provides a similar propellant force to the steel flier plate.

A non-fragmenting backing board is positioned behind the explosive charge to absorb the explosive force in the direction opposite the direction that the steel flier plate is propelled. The backing board may be composed of any material that will absorb or tamp the explosive force and protect the area around the device from unnecessary collateral damage. The backing board may be composed of any suitable material. In the example, the backing board is composed of six layers of cement board cut to the length and width of the steel flier plate.

The steel flier plate and the other components of the assembly are supported by a support structure that positions the assembly proximate to a vehicle trunk or other container that the operator desires to force open. The support structure may be composed of any material that will limit the collateral damage in the area around the vehicle. For example, the support structure may be composed of polyvinyl chloride (“PVC”) components that when propelled by the explosive create little collateral damage due to the low density of the PVC components. The support structure also positions the steel flier plate at a 45 degree angle to the horizontal. Thus, when the steel flier plate is propelled by the detonating cord, the steel flier plate will travel at a 45 degree angle to the horizontal. The steel flier plate may be propelled at different angles when the trunk to be opened has different configurations.

The assembly may include a foam spacer or other material to assist in maintaining a proper spacing with the trunk lid. In the example, the foam is polystyrene or other similar material. The spacer is sized to create an appropriate amount of distance from the steel flier plate to the trunk, such as approximately 1.5 inches. That is, when the assembly is abutted to the trunk lid, the steel flier plate will be 1.5 inches from the trunk lid. In an example, the steel flier plate is positioned at a height that is 4-6 inches below the upper edge of the trunk lid. These dimensions may be altered based on the conditions, such as the type of trunk lid, the size of the steel flier plate, the amount of explosive device used, or other potential conditions.

The assembly may include any other necessary components required to position the steel flier plate, detonate the explosion, and propel the steel flier plate forward. These components may include items such as a tape for affixing the backing board to the steel flier plate, a detonator for the detonating cord, or any other suitable components.

By using and relying on the methods and systems described herein, the user may remotely open a trunk of an automobile or other enclosure without disturbing the contents of the trunk or creating excessive collateral damage. As such, the systems and methods described herein may allow the trunk to be forced open despite the key opening being offset from the latch or if the trunk does not have an external lock. These systems and methods will open the trunk while dissipating the explosive force that is directed away from the steel flier plate. Further, the assembly and the support structure will be of a material that is light enough to be positioned remotely by a robot or other mechanical delivery system. In an example, the assembly and the support structure will further be constructed of materials that are readily available as commercial off-the-shelf materials.

### Detailed Description

Turning now to the drawings, in which like numerals represent like (but not necessarily identical) elements throughout the figures, example embodiments of the present technology are described in detail.

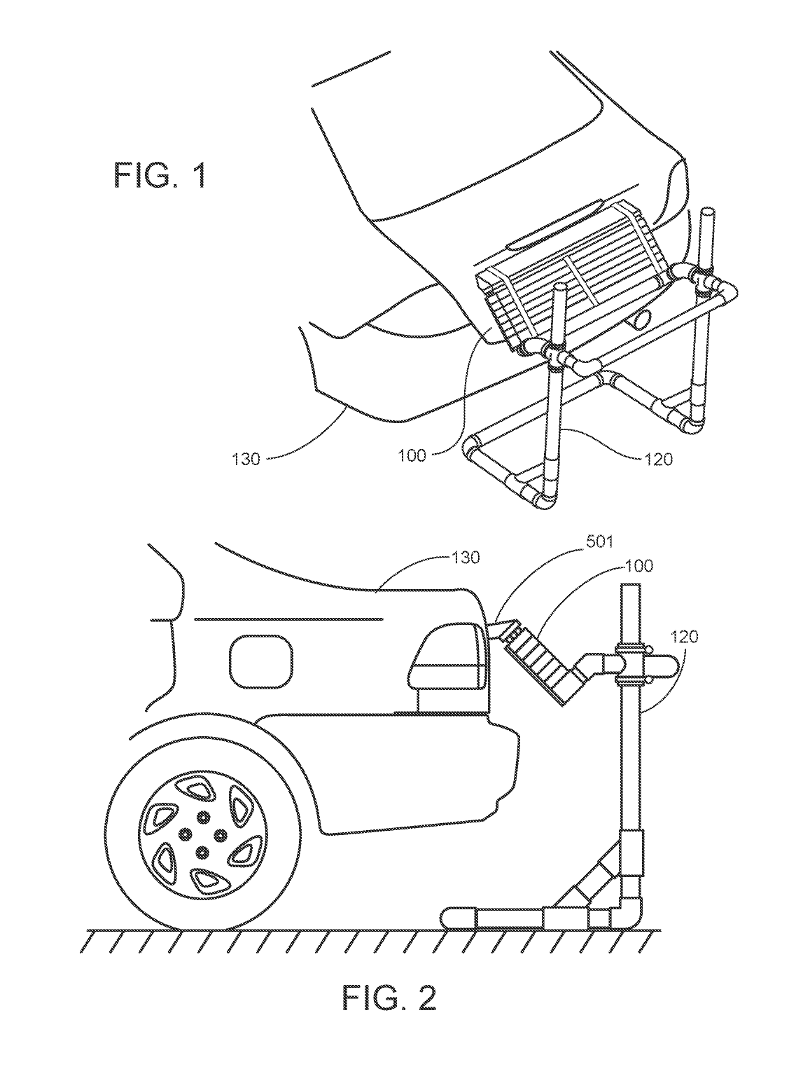

FIG. 1 is an illustration depicting a perspective view of an opening assembly adjacent to a vehicle trunk, in accordance with certain examples.

In an example, an opening assembly 100 is affixed to a structural support 120 and positioned adjacent to a vehicle 130. When actuated the opening assembly 100 propels a steel flier plate 401 into the trunk lid of the vehicle 130 to force the trunk lid to open without disturbing the contents of the trunk or creating excessive collateral damage. For example, the vehicle 130 may be suspected of containing illegal or dangerous items. The operator may be affiliated with a law enforcement organization, the military, or any other suitable group. The operator may be charged with opening the trunk for inspection. If the items in the vehicle 130 are potentially dangerous, the operator may desire to open the trunk remotely. The opening assembly 100 was designed to open the trunk regardless of the position of the lock, such as on a vehicle with the lock offset from the latch.

Any other suitable container may be opened via the opening assembly, such as a box lid, a door, a window, or any other suitable enclosure opening that an operator desires to force open.

FIG. 2 is an illustration depicting a side view of an opening assembly adjacent to a vehicle trunk, in accordance with certain examples.

As depicted, the opening assembly 120 is positioned below the upper edge of the trunk lid. In an example, the opening assembly 120 is positioned 6 inches below the upper edge. The opening assembly 120 is positioned to allow the opening assembly 120 to touch, or nearly touch, the trunk lid. The foam spacer 501, described in greater detail with respect to FIG. 5A, is sized to position the opening assembly 120 accurately a preferred distance away from the trunk.

FIG. 3 is an illustration depicting a front view of a backing board assembly 301, in accordance with certain examples.

The opening assembly 120 includes a series of one or more non-fragmenting backing boards in a backing board assembly 301 to absorb the explosive force in the direction opposite the direction that the steel flier plate 401 is propelled. The backing board assembly 301 may be composed of any material that will absorb or dissipate the explosive force and protect the area around the device from unnecessary collateral damage. The backing board assembly 301 may be composed of any suitable material. In the example, the backing board is composed of six layers of cement board cut to the length and width of the steel flier plate 401. The individual pieces of backing board in the backing board assembly 301 may be secured with a banding device 302. The banding device 302 may be tape, tie wraps, plastic bands, or any suitable device for securing the backing boards together. In another example, an adhesive or any other method of securing the backing boards may be employed.

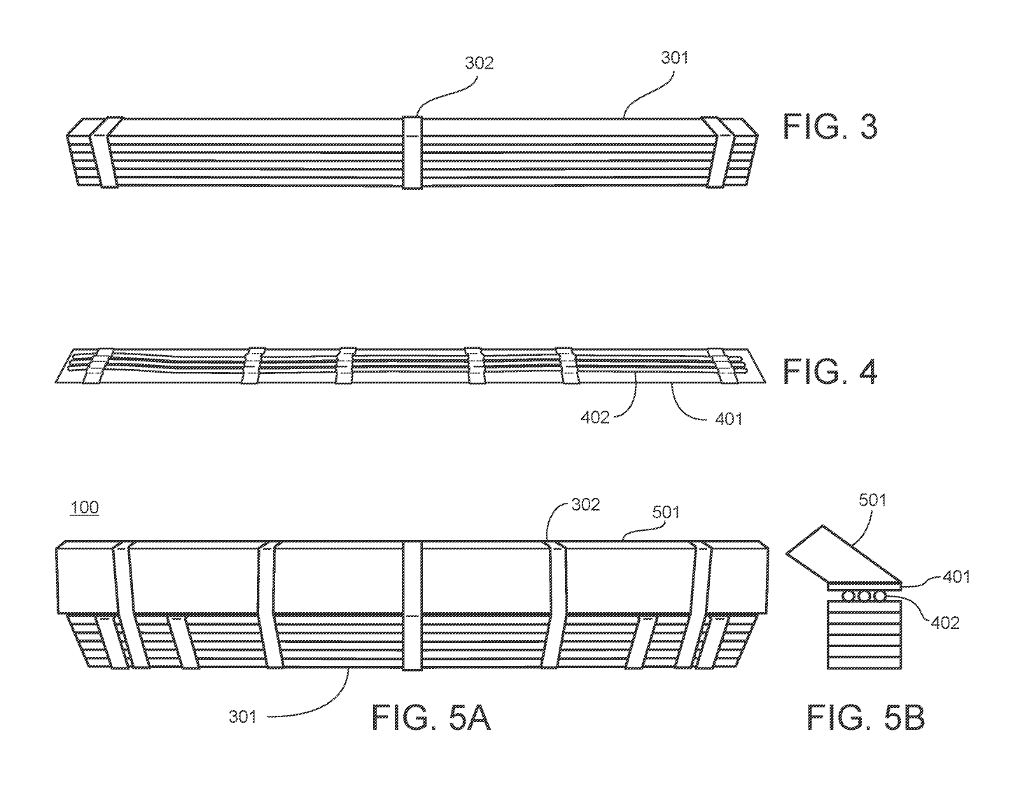

FIG. 4 is an illustration depicting a front view of steel flier plate 401 with an explosive device 402 affixed, in accordance with certain examples.

The steel flier plate 401 is a flat section of metal that is propelled into the trunk lid. In the example, the steel flier plate 401 is a section of steel strap that is approximately 3 feet long, 2 inches wide, and ¼ inches thick. The steel flier plate 401 may be constructed of any suitable metal, such as iron, carbon steel or stainless steel. The steel flier plate 401 should be dense enough to provide sufficient force when propelled to force the trunk lid open.

An explosive device 402 is affixed to the steel flier plate 401 to propel the steel flier plate 401 into the trunk. In an example, the explosive device 402 is comprised of 2-3 strips of 50 grain detonating cord. Any other explosive device 402 or material may be utilized if it provides a similar propellant force to the steel flier plate. The explosive device 402 may be affixed to the steel flier plate 401 in any suitable manner, such as by a banding device 302 or adhesive. The explosive device 402 should be sized to propel the steel flier plate 401 with sufficient force to open the trunk without creating an excessive amount of collateral damage.

The steel flier plate 401 is also affixed to the backing board assembly 301 to absorb the explosive force in the direction opposite the direction that the steel flier plate 401 is propelled. The steel flier plate 401 may be affixed to the backing board assembly 301 in any suitable manner, such as by a banding device 302 or adhesive. When affixed, the explosive device 402 is sandwiched between the steel flier plate 401 and the backing board assembly 301. Thus, when detonated, the steel flier plate 401 is propelled in one direction and the backing board assembly 301 absorbs much of the energy in the opposite direction.

FIG. 5A is an illustration depicting a front view of an opening assembly 100, in accordance with certain examples.

The opening assembly 100 may include a foam spacer 501 or other material to assist in maintaining a proper spacing with the trunk lid. In the example, the foam spacer 501 is polystyrene or other similar material. The foam spacer 501 is sized to create an appropriate amount of distance from the steel flier plate 401 to the trunk, such as approximately 1.5 inches. That is, when the foal spacer 501 of the opening assembly 100 is abutted to the trunk lid, the steel flier plate will be 1.5 inches from the trunk lid. In an example, the steel flier plate 401 is positioned at a height that is 4-6 inches below the upper edge of the trunk lid. These dimensions may be altered based on the conditions, such as the type of trunk lid, the size of the steel flier plate 401, the amount of explosive device 402 used, or other potential conditions.

The foam spacer 501 may be affixed to the opening assembly 100 in any suitable manner, such as by a banding device 302 or adhesive.

FIG. 5B is an illustration depicting a side view of an opening assembly, in accordance with certain examples.

As shown, the foam spacer 501 is affixed to the top of the steel flier plate 401. The explosive device 402 is shown sandwiched between the steel flier plate 401 and the backing board assembly 301. In this configuration, when the explosive device 402 is detonated, the steel flier plate 401 is propelled away from the explosive device 402 and the backing board assembly 301 absorbs the energy of the explosion in the opposite direction.

In an example, the explosive device 402 is wired to a detonator or other device to initiate the explosion of the explosive device 402. The detonator may be threaded through a hole drilled in the backing board assembly 301 or in any other suitable manner affixed to the explosive device 402.

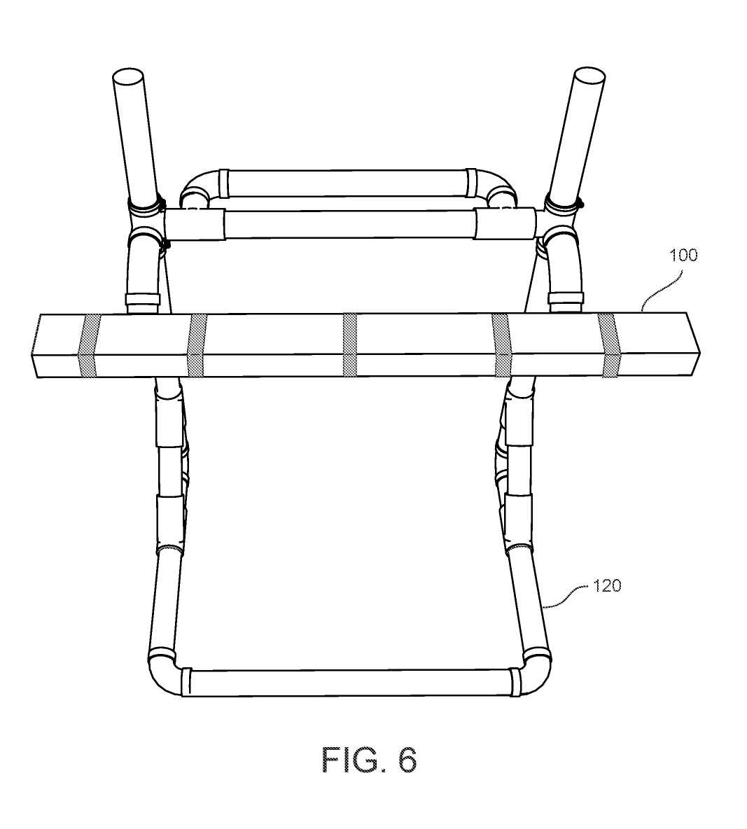

FIG. 6 is an illustration depicting a front view of an opening assembly 100 positioned on a support structure 120, in accordance with certain examples.

The opening assembly 100 is supported by a support structure 120 that positions the opening assembly 100 proximate to a trunk of a vehicle 130 or other container that the operator desires to force open. The support structure 120 may be composed of any material that will limit the collateral damage in the area around the vehicle 130. For example, the support structure 120 may be composed of PVC components that when propelled by the explosion, create little collateral damage due to the low density of the PVC components.

The support structure 120 may also position the steel flier plate at a 45 degree angle to the horizontal. Thus, when the steel flier plate 401 is propelled by the explosive device 402, the steel flier plate 401 will travel at a 45 degree angle to the horizontal.

The opening assembly 100 may be affixed to the support structure 120 via any suitable manner, such as by a banding device 302 or adhesive. In an example, the opening assembly 100 rests on a plate 701 (not shown in FIG. 6) of the support structure 120 that positions the opening assembly 100 at the proper height and angle.

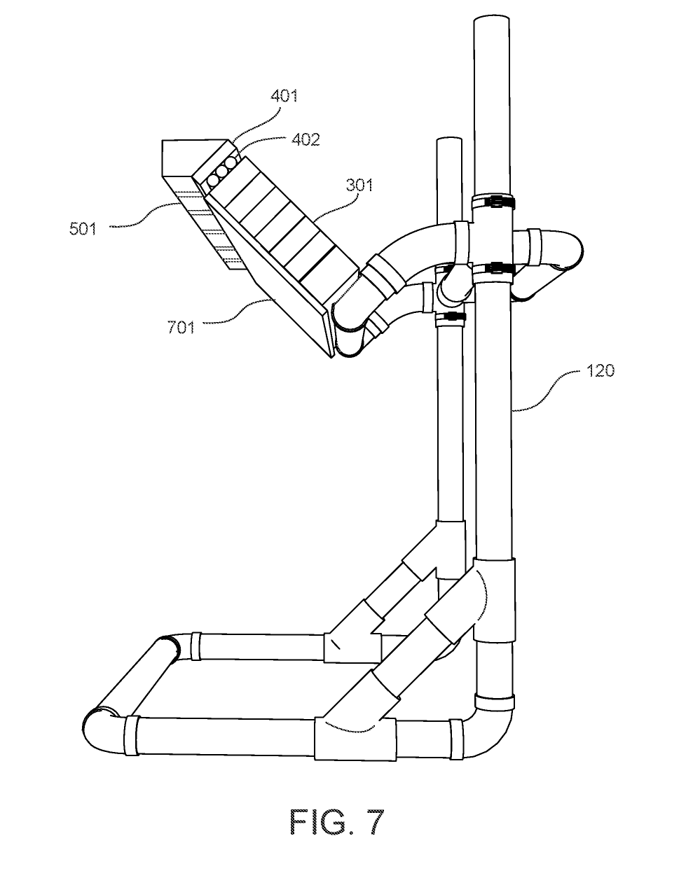

FIG. 7 is an illustration depicting a side view of an opening assembly positioned on a support structure, in accordance with certain examples.

As shown in FIG. 7, the opening assembly is supported by a plate 701 of the support structure 120. The plate 701 may be adjustable to allow the proper height and angle for the opening assembly 100. The plate 701 may be constructed of any suitable material, such as PVC or cement board.

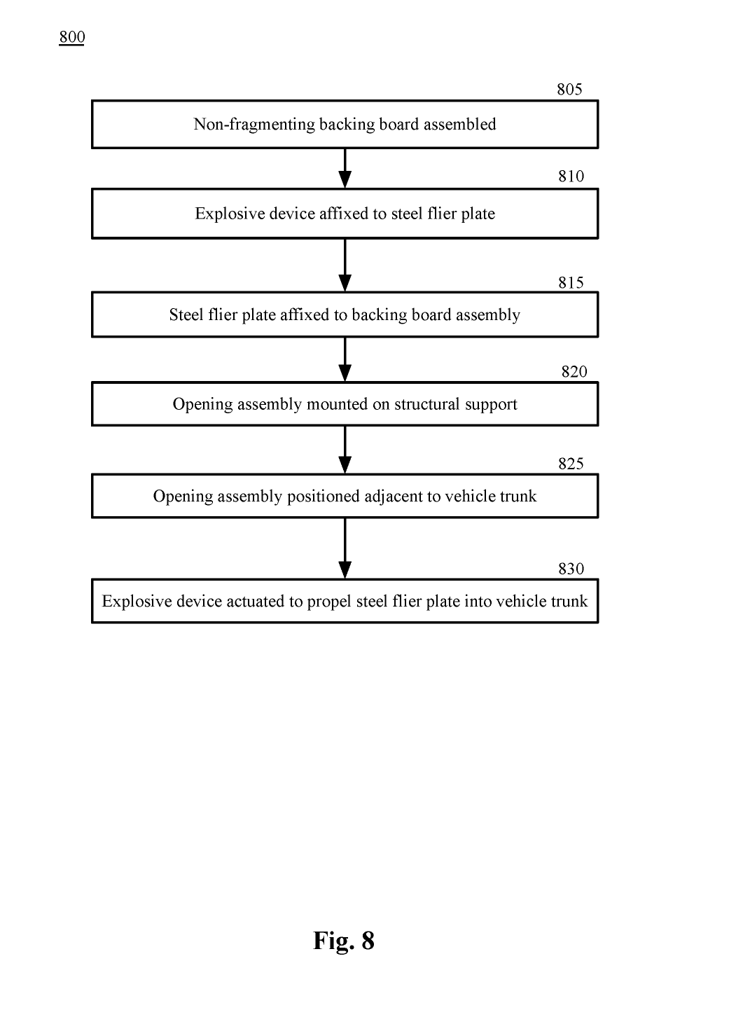

FIG. 8 is a block flow diagram depicting a method 800 for an opening assembly 100 to be assembled and operated, in accordance with certain examples.

In block 805, the backing board assembly 301 is assembled, as described herein with respect to FIG. 3. The amount of cement boards used in the backing board assembly 301 may vary based on the amount of explosive used, the size of the steel flier plate 401, the value of items in the surrounding area, or any other suitable factors.

In block 810, the explosive device 402 is affixed to the steel flier plate 401, as described herein with respect to FIG. 4.

In block 815, the steel flier plate 401 is affixed to the backing board assembly 301. As described herein, the explosive devices 402 is sandwiched between the steel flier plate 401 and the backing board assembly 301.

In block 820, the opening assembly 100 is mounted on the support structure 120. The support structure 120 is adjusted to position the opening assembly 100 at a particular height and angle. The particular height and angle are selected based on the height and type of trunk lid and latching mechanism to be opened.

The detonator of the explosive device 402 is connected to the explosive device 402 to initiate the explosion.

In block 825, the opening assembly 100 is positioned adjacent to a trunk of a vehicle 130. In an example, the foam spacer 501 is positioned to touch, or nearly touch, the trunk lid 4-6 inches below the upper edge of the trunk lid. In an example, a robotic device is employed to position the opening assembly 100 when dangerous contents are suspected to be in the trunk of the vehicle 130.

In block 830, the explosive device 402 is actuated to propel the steel flier plate 401 into the trunk of the vehicle 130. The actuation may be initiated by any suitable device or mechanism. For example, an electrical signal may be delivered to the detonator, which causes a detonation of the explosive device 402.

Upon being detonated, the explosive device 402 propels the steel flier plate 401 into the trunk lid at the preferred speed and angle to force the trunk lid open. The force is sufficient to overcome the trunk latch that is keeping the trunk lid closed. The force may cause deformation of the trunk lid and the surrounding structure of the vehicle 130. However, the force is configured to not cause significant damage to the contents of the trunk. Also, due to the damping effects of the backing board assembly 301, the explosion causes minimal collateral damage to the surrounding area. In an example, portions of the backing board assembly 301 are pulverized by the force of the explosion into a dust or powder. Pieces of the support structure 120 are potentially propelled in various directions. However, due to the materials of construction, such as PVC, the pieces are designed to cause minimal amounts of collateral damage.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. An opening assembly to remotely open a trunk of an vehicle or other enclosure without disturbing the contents of the trunk or creating excessive collateral damage, comprising:
a steel flier plate, the steel flier plate being a flat metal plate to be propelled into a lid of a vehicle trunk;
an explosive device affixed to the steel flier plate, the explosive device being sized to propel the steel flier plate in a direction and with sufficient velocity to force open the lid without causing damage to one or more products inside the vehicle trunk; and
a backing board assembly positioned behind the explosive charge to damp the explosive force in a direction opposite the direction in which the steel flier plate is propelled.

2. The opening assembly of claim 1, further comprising a foam spacer to allow the opening assembly to be positioned in an appropriate location proximate to the vehicle trunk.

3. The opening assembly of claim 1, further comprising a support structure to allow the opening assembly to be positioned in an appropriate location proximate to the vehicle trunk.

4. The opening assembly of claim 2, wherein the support structure is manufactured from sections of polyvinylchloride.

5. The opening assembly of claim 1, further comprising a detonation mechanism to cause the explosive device to detonate.

6. The opening assembly of claim 1, wherein the backing board assembly is comprised of one or more layers of cement board.

7. The opening assembly of claim 1, wherein explosive device is comprised of strips of detonation cord.

8. The opening assembly of claim 1, wherein the steel flier plate is propelled into the trunk lid at approximately a 45 degree angle to the horizontal.

9. A method to assemble and operate an opening assembly, comprising:
assembling a backing board assembly by stacking one or more backing boards and securing the backing board assembly with one or more banding devices;
affixing an explosive device to a steel flier plate;
assembling an opening assembly by stacking the steel flier plate with the affixed explosive device onto the backing board assembly with the explosive device between the steel flier plate and the backing board assembly and securing the opening assembly with one or more banding devices;
affixing a foam spacer to the opening assembly;
positioning the opening assembly in an appropriate location proximate to a vehicle trunk; and
actuating a detonator to cause the explosive device to detonate and the steel flier plate to be propelled into a lid of the vehicle trunk and cause the lid to open.

10. The method of claim 9, further comprising affixing the opening assembly onto a support structure to allow the opening assembly to be positioned in an appropriate location proximate to the vehicle trunk.

11. The method of claim 9, further comprising connecting the detonator to the explosive device.
